(19) United States
(12) Patent Application Publication
(10) Pub. No.: US 2009/0181659 A1
(43) Pub. Date: Jul. 16, 2009

(54) METHOD AND ARRANGEMENT FOR MANAGEMENT OF VIRTUAL MEETINGS

(76) Inventors: Marika Stálnacke, Luleé (SE); Olof Lundström, Stockholm (SE); Tommy Arngren, Södra Sunderbyn (SE); Tor Minde, Gammelstad (SE)

Correspondence Address: ERICSSON INC., 6300 LEGACY DRIVE, M/S EVR 1-C-11, PLANO, TX, 75024, US

(21) Appl. No.: 12/299,675

(22) PCT Filed: May 5, 2006
(86) PCT No.: PCT/SE06/50105

§ 371 Date: Nov. 5, 2008

(51) Int. Cl. H04M 3/42; G06Q 10/00

(52) U.S. Cl. 455/416; 705/9

(57) ABSTRACT

The present invention relates to a method and arrangement for managing a virtual meeting for at least two participants wherein each participant uses his/her mobile phone for communicating with the other participants and an identifier of each participant is provided to said arrangement, the arrangement comprises means for handling an entering procedure to the virtual meeting for each participant, means for handling a login procedure for each participant, and means for handling a startup procedure for each participant. The arrangement comprises means for identifying each participant during said procedures by the provided identifier whereby said identifier is associated with subscriber information adapted to be stored in on storing means connectable to the mobile phone used by the respective participant.

### FIELD OF THE INVENTION

The present invention relates to method and arrangement for managing a virtual meeting, in particular to identification of participants of the virtual meeting.

### BACKGROUND

“Virtual meetings” are very common in today's business life, in particular since both small and large enterprises and other organizations nowadays have the whole globe as their working environment.

A “virtual meeting” is a meeting booked in advance or prepared ad-hoc involving at least one participant at another venue stationary or mobile at a distance from the first venue. The communication and real-time collaboration between the venues are supported by network functions and often involve richer communication than basic voice conversation, e.g. to enable document collaboration, one2one in-conference communication and video conferencing.

Participants of a virtual meeting need to login to the conference system, in order to actively access and use the communication and real-time collaboration tools provided by the virtual meeting.

Existing technologies and solutions for virtual meetings include voice conferencing, video conferencing and PC based collaboration tools for sharing presentations, documents and applications. A common setup for a virtual meeting is to use two systems—one for the voice or possibly video part and one for the document sharing part. This results in dial-in and log-in procedures including entering of passwords for two separate systems.

Some PC based tools integrate voice and video with the document collaboration, using web cameras and VoIP. Most web conferencing systems support Instant Messaging and presence functionality. Connections to existing calendar applications, contacts and corporate directories are provided by several existing products. Ad-hoc meetings can be arranged using these features.

Furthermore, people attending meetings while on the move cannot document digitally (take notes etc) and store during the meeting (when they are lean and active).

Minutes of meeting and presentations will be distributed to the meeting participants after the meeting and many of the participants have their own notes from the meeting.

Today the minutes of meeting and presentations are distributed via email or available via web pages (Quickplace, etc). Appointed person at the meeting put together the minutes of meeting, collect all presentations and make all meeting information available for meeting participants.

There exist solutions where presentations, including video and slides, can be viewed in media players, but these solutions do not support automatic and logical logging of meeting data into a knowledge database for easy access (visualization) to specific information based on time, event, access rights etc.

With today's solutions, participants of virtual meetings can either attend in an active way by bringing their personal computers to the meeting, or they can attend lean by coming without their PC.

Being active means that the participant is logged in to the meeting and can be identified. The identifier used to identify the active participant is usually an identifier created only to be used for the virtual meeting by the meeting application. The active participant can therefore contribute to discussions and work on shared documents. To do this, participants need to hear what is being said and by whom, be heard by others, have an overview of the other participants and see/edit presentations and other documents. Active participants can also for example invite extra participants to the meeting ad-hoc, search for information or quietly confer with another participant on the side.

Being lean means, with today's solutions, that the participant cannot be active. The lean participant does not have any tool (e.g. PC or PDA) for communicating with other and is not logged in to the meeting and cannot be identified by the other participants via a real-time collaboration tool, but it is possible to introduce oneself to the other meeting participants by using a common microphone. Thus, a lean participant is neither able to work on shared documents for example.

A common set-up for a virtual meeting is one conference room with several participants, one or two people attending remotely from their own office plus a few people on-the-move calling in.

Assuming the conference room is equipped with a projector and screen, and one of the participants in the conference room is acting as a meeting moderator. The meeting moderator brings a laptop for the real-time collaboration with the remote participants and is logged in to the meeting. That implies that the meeting moderator is an active participant and the other participants in the physical conference room are lean participants. The lean participants can still see presentations and other documents, and everyone in the room can obviously see and talk to each other. A speaker phone or PC-based voice connection allows communication with the remote participants. However, as stated above, those attending lean are not personally logged in to the virtual meeting, which creates problems in relation to the remote participants—their presence is not obvious and they in turn have no overview of the remote meeting participants. Those sitting far away from a microphone often have problems being heard. In addition, lean participants cannot write in shared documents or on virtual white boards and they cannot share material of their own.

Lean participants on the move can experience difficulties identifying who is currently speaking and even have problems hearing what is being said. They can neither see nor share presentations or other documents.

Many people have to, or want to, attend a meeting lean, since they do not want to carry the laptop or Personal Digital Assistant (PDA) to the meeting room. That implies that not everyone will be fully active, which creates problems for the meeting participants.

It is therefore desirable to achieve a solution where the lean participants, i.e. participants without a laptop or PDA, can be identified by other participants and actively participate in the meeting.

### SUMMARY

Thus an object of the present invention is to achieve a method and an arrangement that makes it possible for all participants to be identifiable irrespective of if the participants are lean or active.

The object is achieved by letting each participant using his/her mobile phone for communicating with the other participants, wherein an identifier preferably associated with SIM-card related information is used to identify the participants during the meeting. An arrangement for managing a virtual meeting is therefore provided comprising means for handling an entering procedure of each participant, means for handling a login procedure of each participant, means for handling a startup procedure of each participant, and means for identifying each participant by an identifier during said procedures.

Thus, the arrangement according to the present invention makes it possible to identify all participants irrespective of if the participants are lean or active.

A method is also provided adapted to be implemented in said arrangement for managing a virtual meeting for at least two participants wherein each participant uses his/her mobile phone for communicating with the other participants and an identifier of each participant is provided to said arrangement The method comprising the steps of handling an entering procedure to the virtual meeting for each participant, handling a login procedure for each participant, handling a startup procedure for each participant, and identifying each participant during said procedures by the provided identifier whereby said identifier associated with said subscriber information adapted to be stored on storing means connectable to the mobile phone used by the respective participant, makes it possible to identify all participants irrespective of if the participants are lean or active.

The identifier may be a phone number of the respective mobile phone, IMSI or a SIP URI of the respective mobile phone. The identifier is preferably stored on a SIM-card connectable to the mobile phone.

According to one embodiment, the arrangement is a server in a client server solution, and according to a further embodiment, the arrangement is a mobile phone adapted to act a moderator peer in a peer to peer solution.

An advantage with the present invention is that users can attend virtual meetings lean, i.e. by using only a mobile phone that the participant yet usually carry, and yet be fully active. That means that the quality of the virtual meeting will be enhanced, mainly in terms of sound quality and presence overview, both for participants on-the-move and those present in a conference room. The ability to share documents, add ad-hoc participants and confer on the side will also contribute to meeting quality.

A further advantage is that the flexibility will increase, since the ability to effectively include participants on-the-move means that meetings can be scheduled whenever potential participants are free, regardless of where they are. There is no need to wait for them to be in a place where they can hook up their PC or attend physically. Flexibility is also increased in the sense that participants can attend parts of a meeting, be invited ad-hoc and be fully active.

A further advantage is that the active contribution of all meeting participants leads to better meeting results and shorter meeting times, i.e. increased meeting efficiency saving time for working people. On a company level, there is a potential productivity increase. The better meeting quality and convenience to (ad-hoc) join a meeting will make people more inclined to set up virtual meetings, which means reduced time to complete tasks. Better results from collaborations within geographically distributed working groups/companies.

A further advantage is that mobile operators will gain a major competitive edge versus PC-based solutions. Also, people attending remotely via mobile phone often reduced to a “voice from above” have difficulties to take active part in the meeting with no direct contact (eye, gesture, whisper) to other participants and difficulties to actively contribute with media (video, pictures) in the meeting. These drawbacks are avoided by the present invention.

A further advantage with the present invention is that the meeting can theoretically start even before all meeting participants have entered a specific location, typically different conference rooms; thus, the meeting does not require a specific meeting location to get started. During the meeting, everyone uses their mobile phone for audio communication, but also for sharing of presentations, documents, whiteboard etc. This is particular relevant for people attending the meeting remotely.

### BRIEF DESCRIPTION OF THE DRAWINGS

FIG. 1 illustrates the entering procedure according to the client server embodiment of the present invention.

FIG. 2 illustrates the log in procedure according to the client server embodiment of the present invention.

FIG. 3 illustrates the startup procedure according to the client server embodiment of the present invention.

FIG. 4 illustrates the entering procedure according to the peer-to-peer embodiment of the present invention.

FIG. 5 illustrates the log in procedure according to the peer-to-peer embodiment of the present invention.

FIG. 6 illustrates the startup procedure according to the peer-to-peer embodiment of the present invention.

FIG. 7 illustrates the procedure of accessing meeting content before the meeting according to an embodiment of the present invention.

FIG. 8 shows an example of how the Server logs meeting data during the meeting and stores the information in its database according to an embodiment of the present invention.

FIG. 9 shows an example how individual participants can log personal data during the meeting.

FIG. 10 shows the scenario when Participant A fetches meeting content from the server database after the meeting has finished.

FIG. 11 shows the scenario when Participant A fetches personal content from the personal database after the meeting has finished.

FIG. 12 illustrates the arrangement according to the present invention.

### DETAILED DESCRIPTION OF THE PRESENT INVENTION

In the following description, for purposes of explanation and not limitation, specific details are set forth, such as particular sequences of steps, signalling protocols and device configurations in order to provide a thorough understanding of the present invention. It will be apparent to one skilled in the art that the present invention may be practised in other embodiments that depart from these specific details.

Moreover, those skilled in the art will appreciate that the functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

Participants that use current solutions for virtual meetings have to bring their comparably big and heavy personal computers to the meeting, at the same time as they usually always carry their comparably small and light mobile phones with them anyway. However, during the virtual meeting the participants either turn off their mobile phones or use them for matters not related to the meeting. The mobile phone is in this way not used for communication and real-time collaboration within the virtual meeting.

Mobile extensions are developed or in the loop for some of the existing virtual meeting tools, however only for smartphones (i.e. phones with a respective “operating system”) and Personal Digital Assistants (PDAs). Feature phones can participate in voice conferences. Video conferencing for 3G feature phones is possible. However, the mobile phone is neither perceived by the users as a virtual meeting real-time collaboration tool, nor does it currently have the required functionality to work as one. The participants are still identified with a special identifier only used for the virtual meeting.

The term mobile phone means in this application a so called “feature phone”, i.e. a “small” mobile device adapted to store subscriber information preferably by means of an integrated SIM-card and where the device is adapted to be connected to a wide area operator-owned cellular network (e.g. WCDMA).

The basic concept of the invention is to enable participants to attend the virtual meeting in a lean and active manner by making the mobile phone the central device of the virtual meeting. Being lean implies in the present application that a meeting participant does not use a laptop or PDA for communicating but only his/her mobile phone. The lean participant is yet able to be active according to the present invention since he is allowed to log in to the meeting by means of the mobile phone, wherein the participant is identified by an identifier associated with the subscriber information adapted to be stored on storing means connectable to the mobile phone. The storing means is preferably at least one SIM card storing subscription information such as IMSI, phone number and SIP URI.

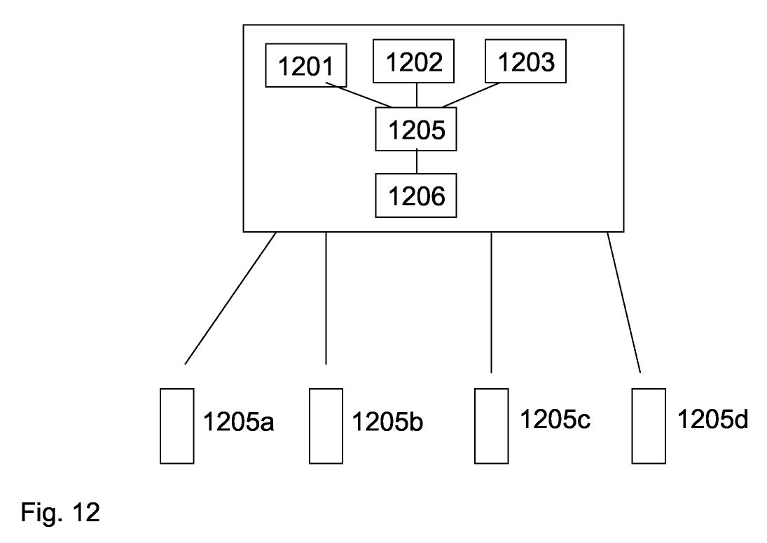

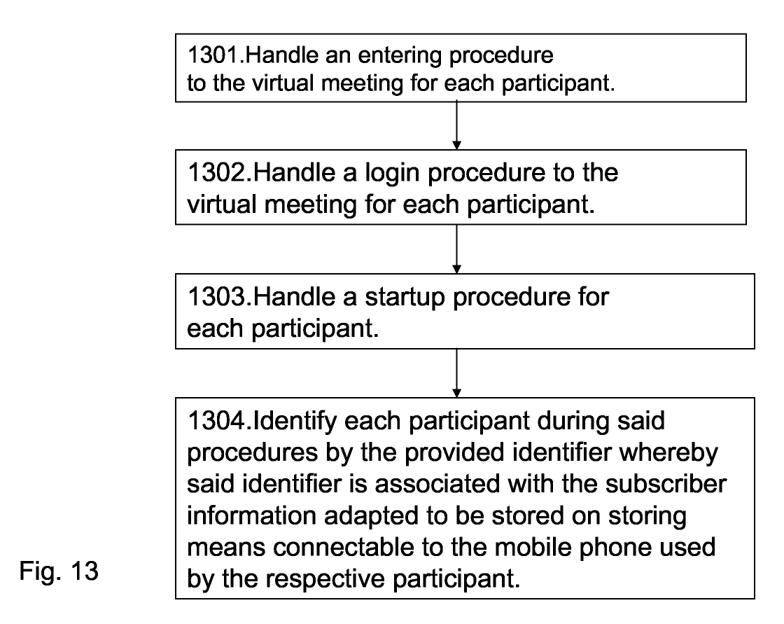

Thus the present invention provides an arrangement according to FIG. 12. The arrangement comprises means 1201 for handling an entering procedure of each participant 1205a-d, means 1202 for handling a login procedure of each participant 1205a-d, means 1203 for handling a startup procedure of each participant 1205a-d, and means 1204 for identifying each participant 1205a-d during said procedures by an identifier associated with the subscriber information adapted to be stored on storing means 1206 connectable to the mobile phone used by the respective participant 1205a-d. The identifier is preferably provided to the arrangement in conjunction with procedures associated with registration or invitation to the meeting. As explained below, the arrangement is preferably implemented in a server or in one or more mobile phones.

With this invention users also referred to as participants enter the virtual meeting by logging in to the meeting using the personal mobile phone as the device, whereby the identifier associated with the subscriber information adapted to be stored on storing means connectable to the mobile phone is used as the identity used in the virtual meeting for identifying the participants. Examples of identities that can be used are an identity associated with the SIM-card number such as the IMSI, the phone number and the SIP URI. Said identities are preferably stored on one or more SIM cards connectable to the mobile phone. An IMS capable mobile phone comprises additional SIM cards that is e.g. adapted to store the SIP URI. The login is preferably done by one-click (hiding PIN-codes, links etc) in a meeting tool schedule/calendar or a meeting reminder in the mobile device. The identifier associated with the subscriber information adapted to be stored on storing means connectable to the mobile phone is used during entering and login procedures. Information such as the capabilities of the mobile phone used in the meeting, the presence outside the meeting and to meeting participants, the location of the participants are also provided to the arrangement of the present invention during the login procedure. The mobile phone can also be used as a tool in the meeting e.g. the microphone may be used for voice input.

The login and entering procedures entail that all participants, attending the meeting with their mobile phone, will be known and present as participants in the virtual meeting. The presence status in the virtual meeting is visible to all participants and this enables displaying of “who is talking” and the possibility of logging meeting data. The audio can be handled by a conference bridge separating, adding and processing the streams for higher audio quality.

Within the lean and active virtual meeting concept, the mobile phone alone or in combination with other devices (e.g. PC) can also be used for sharing (e.g. light video conferencing, whispering, taking notes and showing media), control (e.g. muting of other participants, inviting new participants) and viewing (e.g. slides/documents, map information). Prior to the meeting the mobile phone can be used to view the upcoming meeting details. After the meeting, notes and documents can be reached and displayed.

As stated above, the mobile phone is the central device of the lean and active virtual meeting concept. This implies that the entering procedure involves the phone and the phone entering procedure makes all other functionalities available. Other devices, such as the PC, can be added as complementing devices during the entering procedure, but the voice streams will always go via the mobile phone also when other complementing devices have been added.

The entering procedure can take place in several ways, but according to a first embodiment a Client-Server Solution is used and according to a second embodiment a Peer-to-Peer solution is used. In the Client-Server Solution the arrangement according to the present invention is a centralized server that controls all media streams, whereas in the Peer-to-Peer Solution the arrangement according to the present invention is decentralized to each client (peer), i.e. in a mobile phone or in a plurality of mobile phones. Combinations of the Client-Server solution and the Peer-to-Peer solution may also be used, wherein certain functionalities such as authentication and security is located in the server while the voice management is distributed to the respective peer.

In the client-server solution the server is configured to e.g. manage communication with both common and personal databases as described below, intelligently forward voice and other media streams to the intended receivers, collect presence and other information from related servers, and to handle authentication and login, etc.

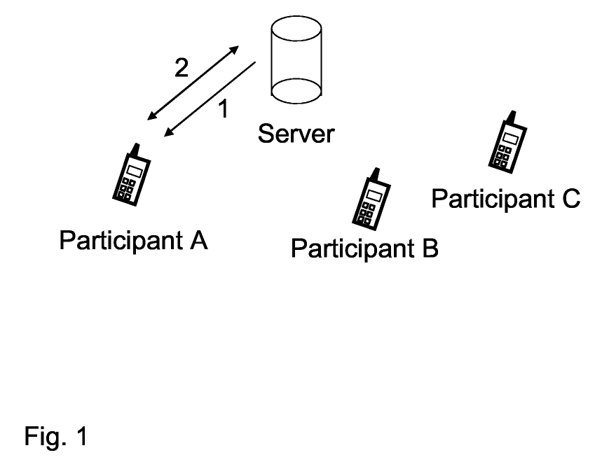

The entering procedure of the client-server solution according to the first embodiment is described below in conjunction with FIG. 1. The two ways of entering the meeting is illustrated in FIG. 1. FIG. 1 illustrates three participants, participant A, B and C acting as clients and a server.

The entering into a scheduled virtual meeting can take place in at least two different ways, either via a reminder or via a fetch of the booking.

If the entering procedure is performed via a reminder, the server is configured to send/update visible content information (time, venue, agenda, participant list) and hidden login information (password, session number) to participant A at the time of booking, wherein the participant is identified by an identifier associated with the subscriber information adapted to be stored on storing means connectable to the mobile phone of participant A. The reminder procedure is illustrated by the arrow denoted 1 in FIG. 1.

If the entering procedure is performed by fetching a booking, participant A fetches visible content information (time, venue, agenda, participant list) and hidden login information (password, session number) from Server. Thus the server is configured to transfer visible content information and hidden login information to the participant A by means of the identifier associated with the subscriber information adapted to be stored on storing means connectable to the mobile phone of participant A. The fetching procedure is illustrated by the arrow denoted 2 in FIG. 1.

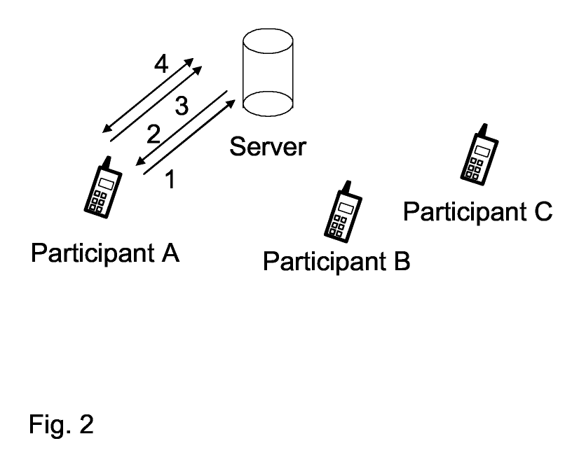

To log in Participant A into the virtual meeting the following four-step process is to be completed in order to transfer information such as Session ID, Capabilities, Context (e.g. location of the participant) and Configurations to the server in accordance with FIG. 2.

Step 3 in FIG. 2. Participant A sends a password to the server. The participant A may have received the password in connection with the meeting reservation, or in connection with a reminder or a fetch from the server when the meeting is about to start. Another alternative is that the server calls each participant when the meeting is about to start and in that case, no password is required.

Step 4 in FIG. 2. Server sends OK to Participant A.

Step 5 in FIG. 2. Participant A sends its Capabilities to the Server, e.g. device type and client. Participant A also sends its Context to the Server, e.g. location, role in meeting (aware functionality) and Control (positioning).

Step 6 in FIG. 2. Participant A and Server update configurations to make sure that the network and the mobile phone supports the same functionalities that are required for the virtual meeting to take place.

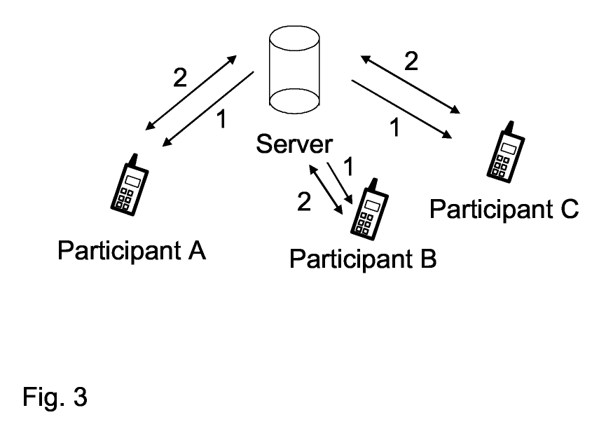

Below is the startup of the virtual meeting described in conjunction with FIG. 3.

Once Participant A (and the other meeting participants) is logged in to the virtual meeting the following activities have to take place in order to startup the meeting.

Step 1 in FIG. 3. Server sends presence update with Context and Capabilities to all logged in participants (A, B and C).

Step 2 in FIG. 3. Server sets up media sessions with all participants.

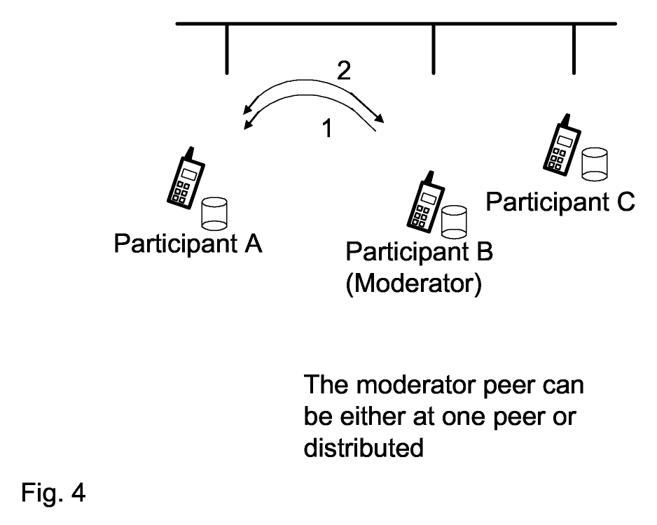

Turning now to FIG. 4 showing the entering procedure of the peer-to-peer solution according to the second embodiment of the present invention.

The entering into a scheduled virtual meeting can take place in at least two different ways, either via a reminder or via a fetch of the booking.

When the entering is performed via a push meeting reminder, the moderator peer (also referred to as m-peer) sends/updates visible content (time, venue, agenda, participant list) and hidden login information (password, session number) to Participant A by means if the identifier associated with the mobile phone of participant A. It should be noted that the m-peer is according to this embodiment a mobile phone. This is illustrated by the arrow denoted 1 in FIG. 4. When the entering is performed via a fetch meeting booking, participant A fetches visible content (time, venue, agenda, participant list) and hidden login information (password, session number) from Moderator peer. This is illustrated by the arrow denoted 2 in FIG. 4.

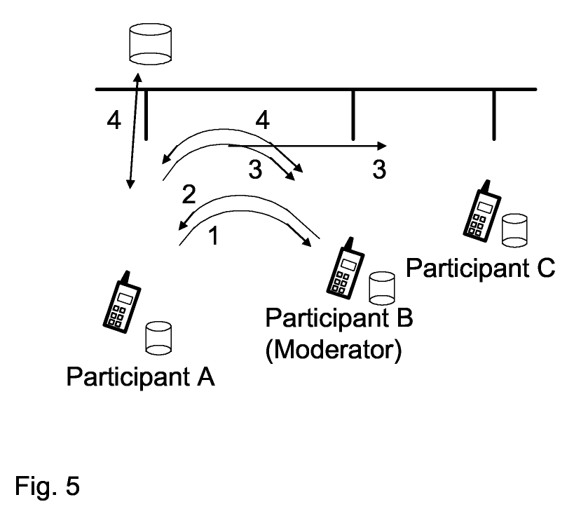

The login process is illustrated in FIG. 5 and described below. To log in Participant A into the virtual meeting the following four-step process is to be completed in order to transfer information such as Session ID, Capabilities, Context and Configurations.

Step 1 in FIG. 5. Participant A sends password to a moderator peer (M-peer).

Step 2 in FIG. 5. M-peer sends OK to Participant A.

Step 3 in FIG. 5. Participant A sends its Capabilities to all Peers, e.g. device type and client. Participant A also sends its Context to all Peers, e.g. location, role in meeting (aware functionality) and Control (positioning).

Step 4 in FIG. 5. Participant A and M-peer update configurations to make sure that the network and the device supports the same functionalities that are required for the virtual meeting to take place.

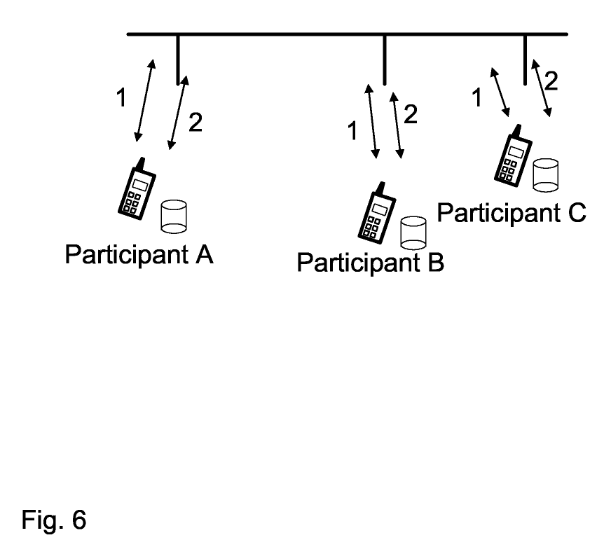

The startup of the virtual meeting is illustrated in FIG. 6.

Once participant A (and the other meeting participants) is logged in to the virtual meeting the following activities take place in order to startup the meeting.

Step 1 in FIG. 6. Peers exchange presence update with Context and Capabilities to all logged in participants (A, B and C).

Media Session Setup

Step 2 in FIG. 6. Peers sets up media sessions with all participants.

It should be noted that all streams in the client-server solution are sent via the server. Also the databases are accessed via the server. In the peer-to-peer solution, any peer may send information to any other peer not necessarily via the M-peer when the login procedure is completed. (Before the login procedure is completed, the streams must be sent via the M-peer.) Further, each peer may control and access its own database without using the M-peer, e.g. when taking notes.

According to a further embodiment of the present invention, an arrangement is provided that makes it possible to share presentation and other documentation when the mobile phone is used as the central device for the virtual meeting, wherein an identifier associated with the subscriber information adapted to be stored on storing means connectable to the mobile phone is used to identify the participant. Said identifier is included in the voice/media streams transmitted between the meeting participants. Thus, the transmitter of the streams can be identified which implies that activities of the participants during the meeting can be logged.

The embodiment for sharing documents based on the client-server solution is described below. The arrangement is a centralized server that controls all the streams. In this embodiment, the server is connected with a database that stores the information that has passed by the server. This procedure facilitates sharing, presentation and documentation of meeting particulars from before, during and after the meeting. Meeting particulars include e.g. voice conversations, documents that have been shared, and media streams.

During the meeting, sharing of media (video, pictures) can help remote participants to get direct contact (eye, gesture, whisper) with the other attendants of the meeting or to get a view of relevant things happening in the close surroundings of a specific participant. Furthermore, it is possible for participants to share media and documents with “themselves” (take notes etc) by sending the media to a personal folder that is accessible after the meeting. The media is sent in a stream that also comprises the identifier that is associated with the mobile phone. Thus the server is configured to identify the sender of a received media stream and is therefore configured to store the media in the personal folder of the identified sender.

All through the meeting, intelligent logging of meeting data into a knowledge database can take place. Each participant's actions (whether voice or sharing of media) can be related to other participant's sharing, e.g. voice comments from meeting participant A about a specific Power Point slide presented by participant B.

After the meeting specific logged information can easily be accessible and visualized based on time, event, and depending on the user's access rights etc. Accurate search for relevant information is possible thanks to the intelligent logging.

In short, with this concept it is possible to share and present different types of meeting data before, during and after the meeting. The sharing can involve either the whole group of participants or just selected ones. It can take place in real-time or when appropriate for the user. This is possible by making the mobile phone the central device of the virtual meeting and thereby enabling all participants to be identified and to be active.

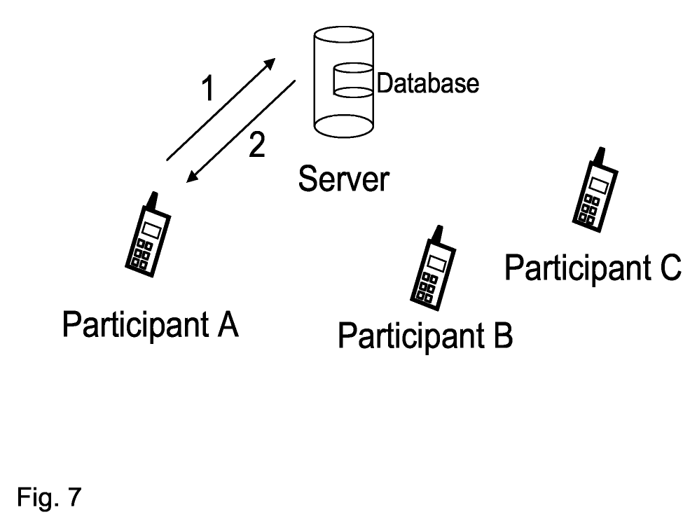

The procedure of accessing meeting content before the meeting has started is described below and is illustrated in FIG. 7.

In the scenario of FIG. 7, before the meeting has started, Participant A has logged in to the meeting. He or she can thereby access (push/pull) available meeting content (time, venue, agenda, participant list, map, etc). To access that content (pull), Participant A sends (1) a request to the meeting server enclosing the identifier associated with the subscriber information adapted to be stored on storing means connectable to the mobile phone of the participant A and selects to see e.g. a map of how to find the way to the conference room. The server is configured to connect to its database, where the meeting content is stored, and fetches the map. The server is further configured to send (2) the map to Participant A by means of said identifier. This can also be performed automatically with a Meeting Reminder before the meeting.

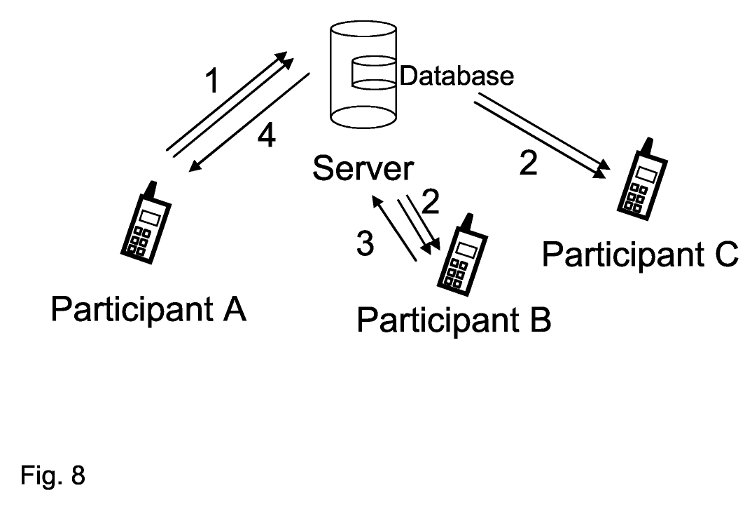

An embodiment of the present invention makes it possible to log meeting data during the meeting. During the meeting, all streams (voice or other media/data streams) are saved in the database as well as transferred to the intended recipient(s). In the example in FIG. 8, Participant A presents a power point-slide (i.e. document sharing) to Participant B and Participant C and informs (i.e. voice conversation) about its content. Participant B then gives some comments back (i.e. voice conversation).

The logging of data is either managed by a server (in a client-server solution) or by a selected/virtual peer (in a peer-to-peer solution). The client-server solution is described below.

Participant A presents a PP-slide show, which is sent to the Server. (The PP-slide show can also be sent to the server beforehand (from e.g. a PC). In this case Participant A only turns the pages (i.e. gives commands) from the mobile phone.) He or she also describes the slide using voice conversation, which initiates another stream to the Server. The Server is configured to log the two data streams (voice and slide) with a time stamp and an event stamp, to convert a copy of the voice stream to a text format, and to store them in its Database. In this case both streams have almost the same time stamp and exactly the same event stamp (as the streams occur at almost the same time and belong to the same topic). The stream comprising the commands of turning the pages of the PP-slides and the voice stream of participant A, respectively, further comprises the identifier associated with the mobile phone. The server is hence able to identify the participant presenting the PP-slides which makes it possible to log the activity of participant presenting the PP-slides.

The two streams are sent on from the Server to both Participant B and C.

Participant B replies with some comments by the means of voice conversation. His or her voice stream comprising the identifier associated with the subscriber information adapted to be stored on storing means connectable to the mobile phone of participant B is sent to the Server. The Server is configured to determine that the voice stream is sent from participant B based on said identifier, to log the stream, to convert a copy of the stream to a text format and to store it in the database. The log of the stream occurs preferably as a time stamp with the current time and as an event stamp, with the same information (still same topic) as the one for Participant A's initial slide and voice conversation in step 1 above.

Participant B's voice stream is sent on from the Server to Participant A but not to Participant C as they are located in the same physical conference room. As stated above, location information of each participant may be provided to the server during the login procedure. The server is therefore able to control the streams such that voice streams between participants located in the same location are blocked.

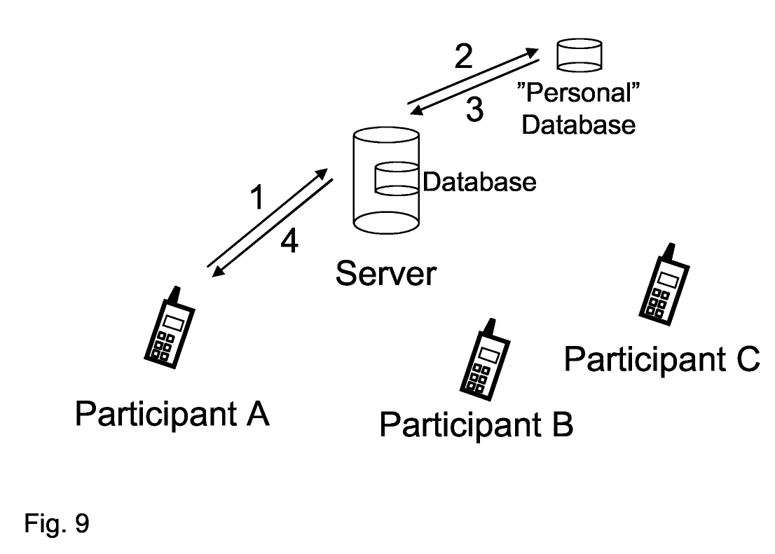

According to a further embodiment, individual participants can log personal data, e.g. take notes, during the meeting. In the following example illustrated in FIG. 9, Participant A takes notes that are sent to his personal database/folder (i.e. this information is not distributed to the other meeting Participants) and stored in his personal database/folder.

Participant A takes a photo of a post-it-note (or other document) with his or her hand-written notes. (Participant A can also type in directly into the device using its keyboard.) The information is sent to the Server, as depicted by arrow 1 in FIG. 9.

The Server is configured to forward the information to the “Personal” Database (or folder) of Participant A based on the identifier associated with the subscriber information adapted to be stored on storing means connectable to the mobile phone of participant A that is included in the stream comprising the personal data. The Personal Database is then configured to log the data stream with a time stamp and an event stamp and stores this information according to arrow 2 in FIG. 9.

The Personal Database is configured to respond with a confirmation message, which is sent back to the Server according to arrow 3 in FIG. 9.

The server is further configured to forward the confirmation message to Participant A according to arrow 4 of FIG. 9.

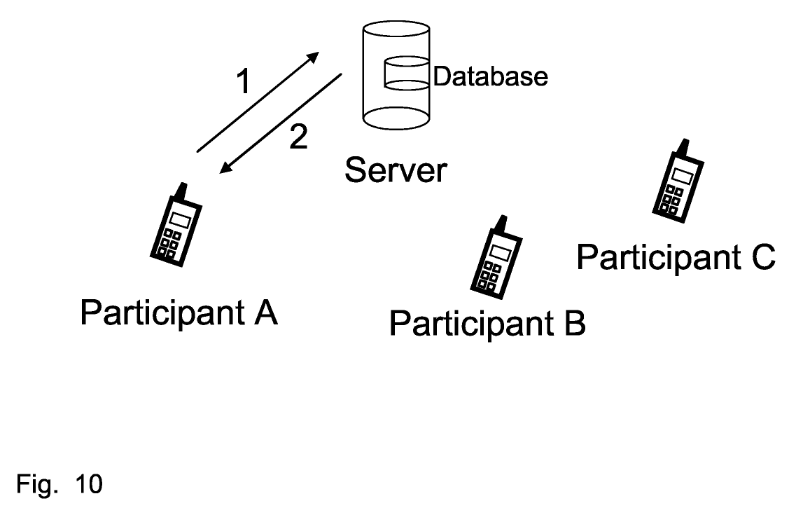

After the meeting, Participant A may want to access content that has been logged during the meeting. Therefore, presentation of documented meeting data after the meeting is achieved by an embodiment of the present invention by means of the server that has packaged this content in different formats for visualization on different devices. His or her login information entails information about what content that he or she has the right to access. Participant A can search for specific time stamps and/or event stamps by sending a request to the Server (see arrow 1 in FIG. 10. The Server is then adapted to fetch the right information from its Database and to send the information back in a format that visualizes the content for Participant A in the best suited way (arrow 2 in FIG. 10).

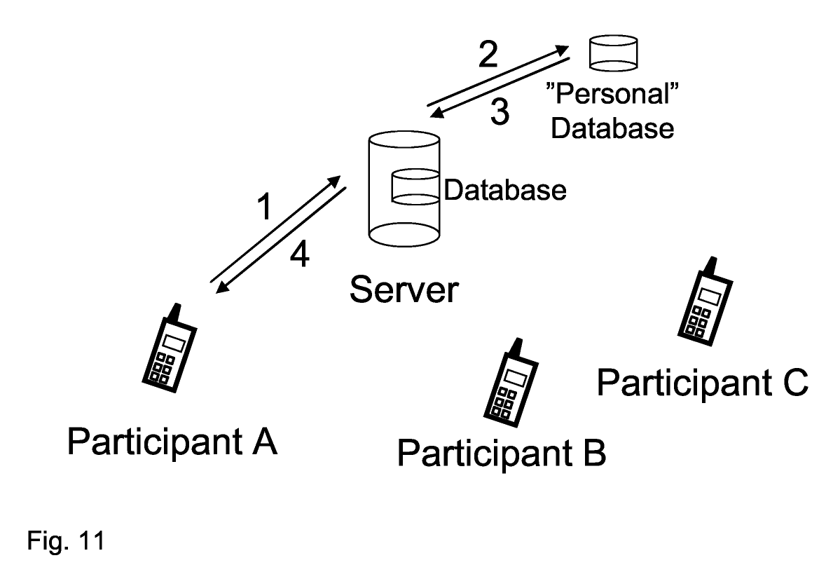

Further, after the meeting, Participant A may want to access the personal content that he or she logged during the meeting. The Personal Database is configured to package this content in different formats for visualization on different devices. Participant A can search for specific time stamps and/or event stamps by sending a request to the Server (see arrow 1 in FIG. 11). The Server is configured to forward the request to the Personal Database of Participant A (see arrow 2 in FIG. 11). The Personal Database is then configured to fetch the right information and to send the information back (via the Server) in a format that visualizes the content for Participant A in the best suited way (arrows 3 and 4 in FIG. 11).

It should be noted that in case some of the participants in the meeting want to use another device (e.g. PC) in addition to the mobile phone they can add this device as part of the entering procedure. This device can then be used for presentation sharing, video streams and other functionalities apart from the audio streams.

As stated above, the present invention provides the arrangement of FIG. 12. Moreover, the invention also provides a method adapted to be performed by said arrangement as illustrated by the flowchart of FIG. 13. The method comprises the steps:

1301. Handle an entering procedure to the virtual meeting for each participant.

1302. Handle a login procedure to the virtual meeting for each participant.

1303. Handle a startup procedure for each participant.

1304. Identify each participant during said procedures by the provided identifier whereby said identifier is associated with the subscriber information adapted to be stored on storing means connectable to the mobile phone used by the respective participant.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. An arrangement for managing a virtual meeting for at least two participants wherein each participant uses his/her mobile phone for communicating with the other participants and an identifier of each participant is provided to said arrangement, the arrangement comprises means for handling an entering procedure to the virtual meeting for each participant, means for handling a login procedure for each participant, and means for handling a startup procedure for each participant, the arrangement comprises means for identifying each participant during said procedures by the provided identifier whereby said identifier is associated with subscriber information adapted to be stored in on storing means connectable to the mobile phone used by the respective participant.

2. The arrangement according to claim 1, wherein the identifier is a phone number.

3. The arrangement according to claim 1, wherein said identifier is an IMSI.

4. The arrangement according to claim 1, wherein the identifier is a SIP URI.

5. The arrangement according to claim 1, wherein the identifier is stored on a SIM-card connectable to the mobile phone.

6. The arrangement according to claim 1, wherein the means for performing the entering procedure comprises means for sending a reminder to the participants by means of said identifier.

7. The arrangement according to claim 1, wherein the means for performing the entering procedure comprises means for responding to a fetch request by the participants by means of said identifiers.

8. The arrangement according to claim 1, wherein the means for performing the login procedure comprises means for receiving mobile phone capabilities and context and means for updating server configuration.

9. The arrangement according to claim 1, wherein the arrangement is a server.

10. The arrangement according to claim 1, wherein the means for performing the startup procedure comprises means for sending presence update with Context and Capabilities to all logged in participants by means of the respective identifier associated with said subscriber information adapted to be stored on storing means connectable to the mobile phone of each participant and means for setting up sessions with the logged in participants.

11. The arrangement according to claim 1, wherein the arrangement is a mobile phone adapted to act as a moderator-peer.

12. The arrangement according to claim 11, wherein the means for performing the startup procedure comprises means for exchanging presence update with Context and Capabilities to all logged in participants by means of the respective identifier associated with said subscriber information adapted to be stored on storing means connectable to the mobile phone and means for setting up media sessions with all logged in participants.

13. The arrangement according to claim 1, comprising means for transmitting meeting information to a participant before the virtual meeting has started by means of an identifier associated with said subscriber information adapted to be stored on storing means connectable to the mobile phone of the participant.

14. The arrangement according to claim 1, comprising means for logging activity of participants during the meeting by means of the respective identifier associated with said subscriber information adapted to be stored on storing means connectable to the mobile phones of the participants.

15. The arrangement according to claim 14, comprising means for making said log accessible by the participants.

16. The arrangement according to claim 1, comprising means for logging personal activity of a participant during the meeting by means of the identifier associated with said subscriber information adapted to be stored on storing means connectable to the mobile phone of the participant.

17. The arrangement according to claim 16, comprising means for making said personal log accessible by the participant.

18. A method in an arrangement for managing a virtual meeting for at least two participants wherein each participant uses his/her mobile phone for communicating with the other participants and an identifier of each participant is provided to said arrangement, the method comprises the steps of:
handling an entering procedure to the virtual meeting for each participant,
handling a login procedure for each participant, and
handling a startup procedure for each participant, the method comprises the step of identifying each participant during said procedures by the provided identifier whereby said identifier is associated with subscriber information adapted to be stored on storing means connectable to the mobile phone used by the respective participant.

19. The method according to claim 18, wherein the identifier is a phone number.

20. The arrangement according to claim 19, wherein said identifier is an IMSI.

21. The method according to claim 18, wherein the identifier is a SIP URI.

22. The method according to claim 18, wherein the step of performing the entering procedure comprises the further step of sending a reminder to the participants by means of said identifier.

23. The method according to claim 18, wherein the step of performing the entering procedure comprises the further step of responding to a fetch request by the participants by means of said identifiers.

24. The method according to claim 18, wherein the step of performing the login procedure comprises the further step of receiving mobile phone capabilities and context and means for updating server configuration.

25. The method according to claim 18, wherein the arrangement is a server.

26. The method according to claim 25, wherein the step of performing the startup procedure comprises the further steps of sending presence update with Context and Capabilities to all logged in participants by means of the respective identifier associated with said subscriber information adapted to be stored on storing means connectable to the mobile phone of each participant and setting up sessions with the logged in participants.

27. The method according to claim 18, wherein the arrangement is a mobile phone adapted to act as a moderator-peer.

28. The method according to claim 27, wherein the step of performing the startup procedure comprises the further steps of exchanging presence update with Context and Capabilities to all logged in participants by means of the respective identifier associated with said subscriber information adapted to be stored on storing means connectable to the mobile phone of each participant and setting up media sessions with all logged in participants.

29. The method according to claim 18, comprising the step of transmitting meeting information to a participant before the virtual meeting has started by means of an identifier associated with said subscriber information adapted to be stored on storing means connectable to the mobile phone of the participant.

30. The method according to claim 18, comprising the step of logging activity of participants during the meeting by means of the respective identifier associated with said subscriber information adapted to be stored on storing means connectable to the mobile phones of the participants.

31. The method according to claim 30, comprising the step of making said log accessible by the participants.

32. The method according to claim 18, comprising the step of logging personal activity of a participant during the meeting by means of the identifier associated with said subscriber information adapted to be stored on storing means connectable to the mobile phone of the participant.

33. The method according to claim 32, comprising the step of making said personal log accessible by the participant.
